(19) United States
(12) Patent Application Publication
(10) Pub. No.: US 2019/0340585 A1
(43) Pub. Date: Nov. 7, 2019

(54) PAYMENT SERVICE DEVICE AND METHOD OF OPERATING THE SAME

(71) Applicant: SK Planet Co., Ltd., Seongnam-si (KR)

(72) Inventors: Ki Chon KANG, Seoul (KR); Ho Keun Jeon, Yongin-si (KR)

(21) Appl. No.: 16/385,212

(22) Filed: Apr. 16, 2019

(30) Foreign Application Priority Data
May 2, 2018 (KR) 10-2018-0050801

(51) Int. Cl. G06Q 20/04; G06Q 30/02; G06Q 20/20

(52) U.S. Cl. CPC G06Q 20/0453; G06Q 20/202; G06Q 30/0226

(57) ABSTRACT

A payment service device and a method of operating the same are provided. The present disclosure provides pre-registering a payment card (for example, a credit card) for the issue of electronic receipts and the accumulation of points and automatically processing the issue of electronic receipts and the accumulation of points when the purchaser performs payment using the registered payment card.

### CROSS-REFERENCE TO RELATED APPLICATIONS

The present application claims priority to and the benefit of Korean Patent Application No. 10-2018-0050801, filed on May 2, 2018, the entire contents of which are incorporated herein by reference.

### TECHNICAL FIELD

The present disclosure relates to a method of registering in advance a payment card (for example, a credit card) to issue electronic receipts and accumulate points and automatically processing the issue of electronic receipts and the accumulation of points when a purchaser performs payment using the registered payment card.

### BACKGROUND

In general, when a purchaser purchases products and performs payment using cash, a credit card, or a terminal, paper receipts are used as evidence for various purposes such as identifying payment details.

To this end, stores issue paper receipts for every payment, but it take a certain amount of time to issue the paper receipts. As a result, the purchaser feels inconvenienced due to waiting a certain amount of time to receive paper receipts.

Further, many purchasers do not think they need the paper receipts, and thus do not accept the issued paper receipts or discard them upon receipt.

In connection with this, electronic receipts has been recently proposed as an alternative of paper receipts, where the electronic receipts is transmitted through a network in a form of data and identified by a terminal of the purchaser.

However, the conventional electronic receipt system further needs an NFC device or a tag for issuing electronic receipts in addition to the existing POS device or may be required to modify a POS application program, and these problems are big obstacles to activating electronic receipts.

Meanwhile, in connection with the issue of electronic receipts, a point accumulation service of accumulating points at a predetermined rate of payment amount may also be performed during a process for payment of the purchaser. The point accumulation service has already been commercialized and provided by various affiliated stores, and many consumers is familiar with the point accumulation service.

However, the conventional point accumulation service may be provided by reading a point card issued to the purchaser or scanning a barcode displayed on a purchaser's terminal when the purchaser performs payment. In this case, there is inconvenience that the purchaser should present the point card or barcode to the affiliated store to accumulate points through the scheme.

Accordingly, the present disclosure proposes a new method of solving the inconvenience during a process of issuing electronic receipts and a process of accumulating points which may be performed with the issue of electronic receipts.

### SUMMARY

The present disclosure has been made in order to solve the above-mentioned problems in the prior art and an aspect of the present disclosure is to pre-register a payment card (for example, a credit card) for the issue of electronic receipts and the accumulation of points and automatically process the issue of electronic receipts and the accumulation of points when the purchaser performs payment using the registered payment card.

In accordance with an aspect of the present disclosure, a payment service device is provided. The payment service device includes: a processor configured to process calculations related to issues of electronic receipts and accumulation of points; and a memory configured to store at least one command executed through the processor, wherein the at least one command includes: an identification command of identifying a payment card which a purchaser registers to issue electronic receipts and accumulate points; and a registration command of registering the payment card in a card company device for issuing electronic receipts and accumulating points so that the card company device receiving a payment approval request for the payment card from an affiliated store terminal can instruct the affiliated store terminal to issue electronic receipts and accumulate points.

Specifically, the at least one command may further include an issue command of, when it is determined that electronic receipts can be issued based on location information of a purchaser terminal, issuing electronic receipts for payment details approved by the card company device.

Specifically, the issue command may include, when a difference between a location of the purchaser terminal identified based on the location information and a location of the affiliated store terminal is shorter than a threshold distance, determining that the electronic receipts can be issued.

Specifically, when it is identified that electronic receipts are issued from the payment service device, the affiliated store terminal may make a request for accumulating points for payment details approved by the card company device.

Specifically, the accumulation of points may be performed according to payment details received from the affiliated store terminal when payment details received from the affiliated store terminal are equal to payment details identified from a predefined affiliated store terminal group.

Specifically, the at least one command may further include an accumulation command of accumulating points for payment details approved by the card company device according to the issue of electronic receipts.

In accordance with another aspect of the present disclosure, a method of operating a payment service device is provided. The method includes: an identification step of identifying a payment card which a purchaser registers to issue electronic receipts and accumulate points; and a registration step of registering the payment card in a card company device for issuing electronic receipts and accumulating points so that the card company device receiving a payment approval request for the payment card from an affiliated store terminal can instruct the affiliated store terminal to issue electronic receipts and accumulate points.

Specifically, the method may further include an issue step of, when it is determined that electronic receipts can be issued based on location information of a purchaser terminal, issuing electronic receipts for payment details approved by the card company device.

Specifically, wherein the issue step may include, when a difference between a location of the purchaser terminal identified based on the location information and a location of the affiliated store terminal is shorter than a threshold distance, determining that the electronic receipts can be issued.

Specifically, the method may further include an accumulation step of accumulating points for payment details approved by the card company device according to the issue of electronic receipts.

Specifically, the accumulation of points may be performed according to payment details received from the affiliated store terminal when payment details received from the affiliated store terminal are equal to payment details identified from a predefined affiliated store terminal group.

Specifically, when payment according to the payment approval request is approved, the card company device may share approved payment details with each terminal belonging to the affiliated store terminal group.

According to a payment service device and a method of operating the same according to an embodiment of the present disclosure, it is possible to improve convenience of a purchaser by pre-registering a payment card (for example, a credit card) for the issue of electronic receipts and the accumulation of points and automatically processing the issue of electronic receipts and the accumulation of points when the purchaser performs payment using the registered payment card.

### DRAWINGS

The above and other aspects, features and advantages of the present disclosure will be more apparent from the following detailed description taken in conjunction with the accompanying drawings, in which:

FIG. 1 is a schematic diagram of a payment service system according to an embodiment of the present disclosure;

FIG. 2 is a schematic diagram of an affiliated store terminal according to an embodiment of the present disclosure;

FIG. 3 illustrates a hardware system for implementing a terminal according to an embodiment of the present disclosure;

FIG. 4 is a schematic diagram of a payment service device according to an embodiment of the present disclosure;

FIG. 5 illustrates a hardware system for implementing a payment service device according to an embodiment of the present disclosure;

FIG. 6 is a flowchart schematically illustrating an operation flow in a payment service system according to an embodiment of the present disclosure;

FIG. 7 is a flowchart schematically illustrating an operation flow in an affiliated store terminal according to an embodiment of the present disclosure; and

FIG. 8 is a flowchart schematically illustrating an operation flow in a payment service device according to an embodiment of the present disclosure.

### DETAILED DESCRIPTION

It should be noted that the technical terms in the specification are merely used for describing a specific embodiment but do not limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

Hereinafter, exemplary embodiments of the present disclosure will be described in detail with reference to the accompanying drawings, equal or similar elements are assigned an equal reference numeral, and an overlapping description thereof will be omitted. Further, in the following description of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the spirit of the present disclosure should not be construed as being limited by the accompanying drawings. In addition to the accompanying drawings, the spirit of the present disclosure should be construed to cover all modifications, equivalents, and alternatives thereof.

Hereinafter, an embodiment of the present disclosure will be described with reference to the accompanying drawings.

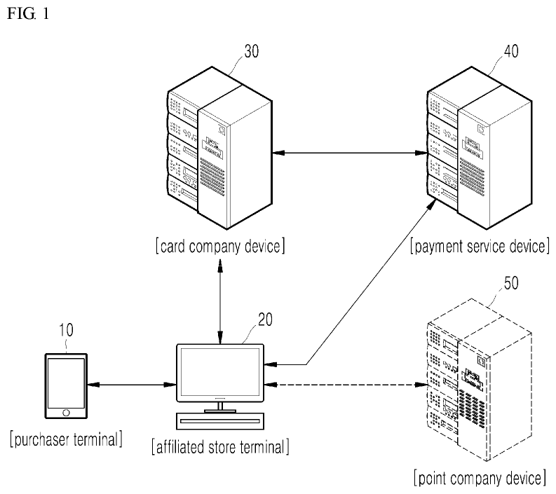

FIG. 1 illustrates a payment service system according to an embodiment of the present disclosure.

As illustrated in FIG. 1, the payment service system according to an embodiment of the present disclosure may include a purchaser terminal 10 of a purchaser, an affiliated store terminal 20 configured to process payment of the purchaser, a card company device 30 configured to process approval of payment for a payment card, and a payment service device 40 configured to process issue of electronic receipts and accumulation of points.

Further, the payment service system according to an embodiment of the present disclosure may further include a point company device 50 configured to process accumulation of points and, in this case, the payment service device 40 may process only issue of electronic receipts.

Hereinafter, for convenience of description, it is assumed that the payment service device 40 processes both the issue of electronic receipts and the accumulation of points as a system configuration except for the point company device 50 is adopted.

The purchaser terminal 10 is a device that displays a result of the issue of electronic receipts and the accumulation of points and may include, for example, a smart phone, a portable terminal, a mobile terminal, a Personal Digital Assistant (PDA), a Portable Multimedia Player (PMP), a telematics terminal, a navigation terminal, a personal computer, a notebook computer, a slate PC, and a tablet PC.

The affiliated store terminal 20 is a device that acquires card information of the payment card from the purchaser and makes a request for approving the payment to the card company device 30 and, when the payment is approved, makes a request for issuing electronic receipts and accumulating points to the payment service device 40 and may correspond to, for example, a Point Of Sales (POS) device within the affiliated store supporting the accumulation of points.

For example, identification information of the payment card for payment may be acquired through a scheme of reading the payment card possessed by the purchaser by a card reader, scanning a barcode displayed on the purchaser terminal 10, or tagging the purchaser terminal 10 through short-range communication.

The card company device 30 is a device that processes approval of payment by the payment card requested from the affiliated store terminal 20 and may correspond to a server operated by the card company that issued the payment card.

The payment service device 40 is a device that processes the issue of electronic receipts and the accumulation of points requested from the affiliated store terminal 20 according to the approval of payment by the payment card.

The payment service server 40 may be implemented in the form of, for example, a web server, a database server, or a proxy server, or may be implemented as a computerized system through installation of one or more of various pieces of software that allow a network load distribution mechanism or a service device to operate on the Internet or another network. Further, the network may be an http network, a private line, an intranet, or another network, and a connection between elements within a payment service system according to an embodiment of the present disclosure may be made through a security network to prevent data from being compromised by an arbitrary hacker or another third party.

The payment service system according to an embodiment of the present disclosure may automatically process the issue of electronic receipts and the accumulation of points based on the above-described configuration when the purchaser performs payment using the payment card.

In connection with this, the current system for issuing electronic receipts may further need an NFC device for issuing electronic receipts in addition to the existing POS device or may be required to modify a POS application program, and these problems are big obstacles to activation of electronic receipts.

Solutions for the problems of electronic receipts may be largely divided into a receipt scanning scheme and an NFC scheme.

The receipt scanning scheme is a scheme in which a consumer generates a photo image through a camera mounted to a smart phone of the consumer based on a paper receipt issued through a POS system, extracting important information therefrom through Optical Character Recognition (OCR) software, inputting the information into the part corresponding to an item of the receipt, and generating an electronic receipt.

This has an advantage in that the electronic receipt can be generated without any requirement such as addition of a device to the store or a modification of the POS application program.

However, a recognition rate of the OCR falls short of our expectation and information in the text form which is different from real receipt information is frequently extracted. Further, the recognition rate significantly varies depending on a photographing quality according to a photographing angle and a light amount when receipts are photographed through a camera.

Data extracted through the scheme cannot be data in the standard text form and thus it is difficult to make a database thereof, and the scheme has a problem in that a consumer should take a photo in order to issue receipts in every payment.

In a Near Field Communication (NFC) scheme, a purchaser of a smart phone having an NFC reading/writing function downloads an electronic receipt application and brings the smart phone into contact with an NFC transceiver to receive electronic receipts by the smart phone through short-range wireless communication.

The NFC scheme has an advantage of issuing electronic receipts through a simple action of bring the smart phone into contact with the transceiver and thus providing purchaser convenience at a high level, but also has a disadvantage in that an additional device which has the NFC reading/writing function that existing legacy POS does not have, is required for short-range wireless communication.

Further, in an environment of the point accumulation service, which may be performed in the process of issuing electronic receipts, the point accumulation service may be used through a scheme of reading a point card issued to the purchaser or scanning a barcode displayed on a terminal of the purchaser when the purchaser performs payment, which inconveniences the purchaser in that the purchaser should present the point card or barcode to the affiliated store to accumulate points through the scheme.

Accordingly, the present disclosure proposes a new method of solving the inconvenience during the process of issuing electronic receipts and a process of accumulating points which may be performed with the issue of electronic receipts and, hereinafter, the configuration of the affiliated store terminal 20 and the payment service device 40 for implementing it will be described in more detail.

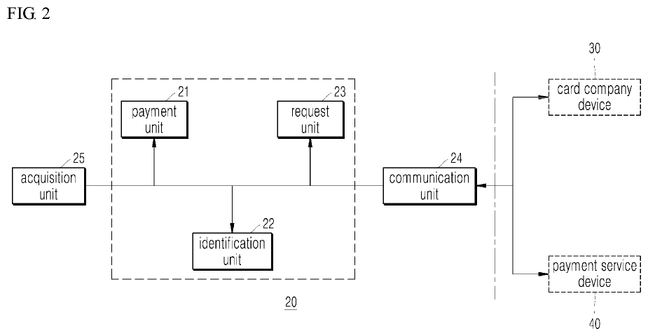

FIG. 2 illustrates the configuration of the affiliated store terminal 20 according to an embodiment of the present disclosure.

As illustrated in FIG. 2, the affiliated store terminal 20 according to an embodiment of the present disclosure may include a payment unit 21 configured to make a request for approving payment, an identification unit 22 configured to identify a target to issue electronic receipts and accumulate points, and a request unit 23 configured to make a request for issuing electronic receipts and accumulating points.

All or at least some of the elements of the affiliated store terminal 20 including the payment unit 21, the identification unit 22, and the request unit 23 may be implemented in the form of a software module or a hardware module executed by the processor or in the form of a combination of a software module and a hardware module.

Meanwhile, the affiliated store terminal 20 according to an embodiment of the present disclosure may further include a communication unit 24 configured to communicate with a card company device 30 and a payment service device 40 and an acquisition unit 25 configured to acquire card information of a payment card in addition to the above-described elements.

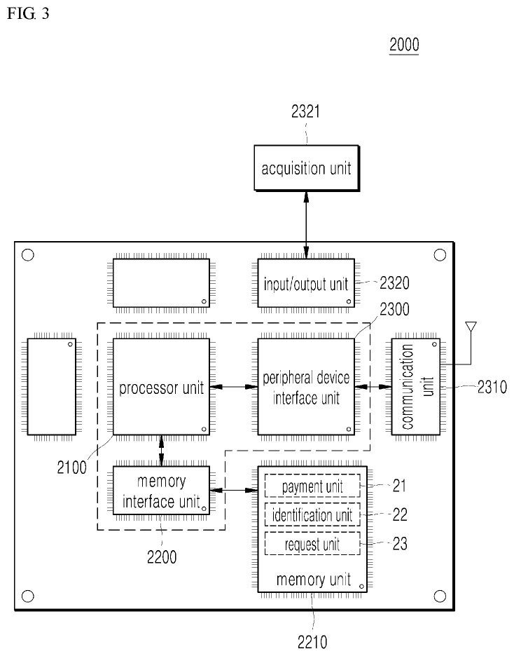

For reference, since the communication unit 24 and the acquisition unit 25 correspond to a communication unit 2310 and an acquisition unit 2321 to be described with reference to FIG. 3, respectively, a detailed description thereof will be made below.

As a result, the affiliated store terminal 20 according to an embodiment of the present disclosure may support the issue of electronic receipts and the accumulation of points based on the above-described configuration when payment by the payment card is approved and, hereinafter, the elements within the affiliated store terminal 20 for implementing it will be described in more detail.

The payment unit 21 performs a function of making a request for approving payment.

Specifically, the payment unit 21 makes a request for approving payment by the payment card to the card company device 30 by transferring a payment approval request to the card company device 30 according to a payment request using the payment card of the purchaser.

At this time, the payment unit 21 may make a request for approving payment by the payment card by acquiring card information of the payment card and transferring a payment approval request including the acquired card information to the card company device 30.

The identification unit 22 performs a function of identifying a target to issue electronic receipts and accumulate points.

Specifically, when the request for payment by the payment card is approved by the card company device 30 and a payment approval response thereto is received from the card company device 30, the identification unit 22 identifies that the payment card by which the request for payment is made is the target to issue electronic receipts and accumulate points based on the received payment approval response.

At this time, the payment approval response received from the card company device 30 may include card information of the approved payment, that is, service target identification information (flag) indicating the target to issue electronic receipts and accumulate points, and the identification unit 22 may identify that the payment card by which the request for payment is made is the target to issue electronic receipts and accumulate points based on the service target identification information.

To this end, the card company device 30 may receive card information of the payment card configured as the target to issue electronic receipts and accumulate points by the purchaser from the payment service device 40 and register and manage the card information, and thus may transmit the payment approval response including the service target identification information (flag) indicating the target to issue electronic receipts and accumulate points to the affiliated store terminal 20 when the payment by the corresponding payment card is approved.

The request unit 23 performs a function of making a request for issuing electronic receipts and accumulating points.

Specifically, when it is identified that the payment card by which the request for payment is made is the target to issue electronic receipts and accumulate points based on the payment approval response received from the card company device 30, the request unit 23 makes a request for issuing electronic receipts and accumulating points for payment details approved by the card company device 30 to the payment service device 40.

At this time, the request unit 23 makes a request for issuing electronic receipts and accumulating points for payment details approved by the card company device 30 by transferring an issuing and accumulating request message including affiliated store information, card information of the payment card, and payment details to the payment service device 40.

In connection with this, when the issuing and accumulating request message is received from the affiliated store terminal 20, the payment service device 40 may issue electronic receipts for payment details to the purchaser who matches the card information and transmit the issued electronic receipts to the purchaser terminal 10, so that the purchaser may identify the issued electronic receipts.

Further, after the electronic receipts are issued, the payment service device 40 may accumulate points corresponding to the payment details of point card information of the purchaser who matches the card information and transmit a result of the corresponding point accumulation to the purchaser terminal 10, so that the purchaser may identify the accumulated points.

To this end, before the electronic receipts are issued and the points are accumulated for the purchaser, the payment service device 40 may register and manage purchaser configuration information including card information of the payment card configured by the purchaser as the target to issue electronic receipts and accumulate points, point card information that matches the card information, and identification information (phone number) of the purchaser terminal 10 in the form of a matching table.

Meanwhile, each element within the affiliated store terminal 20 may be implemented in the form of a software module or a hardware module executed by a processor or in the form of a combination of a software module and a hardware module.

As described above, the software module and the hardware module executed by the processor, and the combination of the software module and the hardware module may be implemented by a hardware system (for example, a computer system).

Accordingly, hereinafter, a hardware system 2000 in which the affiliated store terminal 20 according to an embodiment of the present disclosure is implemented in the hardware form will be described with reference to FIG. 3.

For reference, the following description is an example of the hardware system 2000 in which respective elements within the affiliated store terminal 20 are implemented, and it should be noted that each element and the operation thereof may be different from those in the actual system.

As illustrated in FIG. 3, the hardware system 2000 according to an embodiment of the present disclosure may include a processor unit 2100, a memory interface unit 2200, and a peripheral device interface unit 2300.

The respective elements within the hardware system 2000 may be individual elements, or may be integrated into one or more integrated circuits, and may be combined by a bus system (not shown).

The bus system is an abstraction indicating one or more individual physical buses, communication lines/interfaces, multi-drop, and/or point-to-point connections connected by bridges, adaptors, and/or controllers as appropriate.

The processor unit 2100 may serve to execute various software modules stored in the memory unit 2210 by communicating with the memory unit 2210 through the memory interface unit 2200 in order to perform various functions in the hardware system.

The memory unit 2210 may store the payment unit 21, the identification unit 22, and the request unit 23, which are the elements within the affiliated store terminal 20 described with reference to FIG. 2, in the form of a software module, and may further include an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 2210 includes a cache, a main memory, and a secondary memory, but is not limited thereto, and may include a memory layer structure. The memory layer structure may be implemented through a predetermined combination of, for example, RAM (for example, SRAM, DRAM, or DDRAM), ROM, FLASH, a magnetic and/or optical storage device (for example, a disk drive, a magnetic tape, a Compact Disk (CD), and a Digital Video Disc (DVD)).

The peripheral interface unit 2300 serves to enable communication between the processor unit 1100 and peripheral devices.

The peripheral device may provide different functions to the hardware system 2000 and may include, for example, a communication unit 2310 and an input/output unit 2320 according to an embodiment of the present disclosure.

The communication unit 2310 serves to provide a function of communication with another device. To this end, the communication unit 1310 may include, for example, an antenna system, an RF transceiver, one or more amplifiers, a tuner, one or more oscillators, a digital signal processor, a CODEC chipset, and a memory, but is not limited thereto, and may include a known circuit for performing the function.

Communication protocols supported by the communication unit 2310 may include, for example, Wireless LAN (WLAN), Digital Living Network Alliance (DLNA), Wireless broadband (Wibro), World interoperability for microwave access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, and Wi-Fi Direct. Wired communication networks may include wired Local Area Network (LAN), wired Wide Area Network (WAN), Power Line Communication (PLC), USB communication, Ethernet, serial communication, and optical fiber/coaxial cable, but are not limited thereto and may include any protocol that can provide a communication environment with another device.

The input/output unit 2320 may serve as a controller configured to control an I/O device linked to other hardware systems and may serve to control the acquisition unit 2321 to acquire card information from the payment card in an embodiment of the present disclosure.

The acquisition unit 2321 may have the form of, for example, a card reader for acquiring card information from a magnetic of the payment card of the purchaser, a barcode reader for acquiring card information displayed in the barcode form on the purchaser terminal 10, and an NFC reader for acquiring card information inserted into the purchaser terminal 10 as tag information.

As a result, each element within the affiliated store terminal 20 stored in the memory unit 2210 of the hardware system 2000 according to an embodiment of the present disclosure in the form of a software module may execute an interface with the communication unit 2310 and the input/output unit 2320 via the memory interface unit 2200 and the peripheral device interface unit 2300 in the form of instructions executed by the processor unit 2100, thereby making a request for issuing electronic receipts and accumulating points for payment details approved by the card company device 30 without a separate intervention of the purchaser.

The configuration of the affiliated store terminal 20 according to an embodiment of the present disclosure has been completely described and the configuration of the payment service device 40 will be subsequently described.

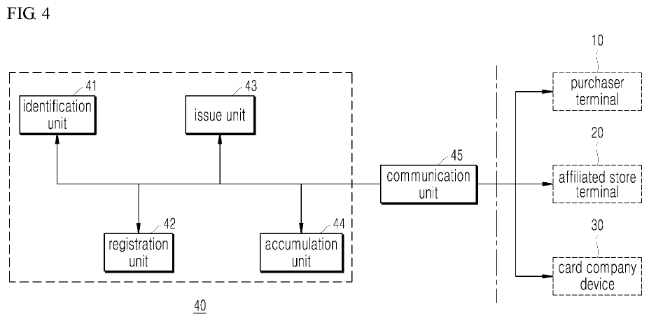

FIG. 4 illustrates a schematic configuration of the payment service device 40 according to an embodiment of the present disclosure.

As illustrated in FIG. 4, the payment service device 40 according to an embodiment of the present disclosure may include an identification unit 41 configured to identify a payment card and a registration unit 42 configured to register the payment card as a target to issue electronic receipts and accumulate points.

Further, the payment service device 40 according to an embodiment of the present disclosure may further include an issue unit 43 configured to issuing electronic receipts and an accumulation unit 44 configured to accumulate points in addition to the above-described elements.

All or at least some of the elements of the payment service device 40 including the identification unit 41, the registration unit 42, the issue unit 43, and the accumulation unit 44 may be implemented in the form of a software module or a hardware module or in the form of a combination of a software module and a hardware module.

The software module may be understood as, for example, an instruction executed by the processor for controlling calculations within the payment service device 40 and the instruction may have the form installed in the memory within the payment service device 40.

Meanwhile, the payment service device 40 according to an embodiment of the present disclosure may further include a communication unit 45 configured to support communication with the purchaser terminal 10, the affiliated store terminal 20, and the card company device 30 in addition to the above-described elements.

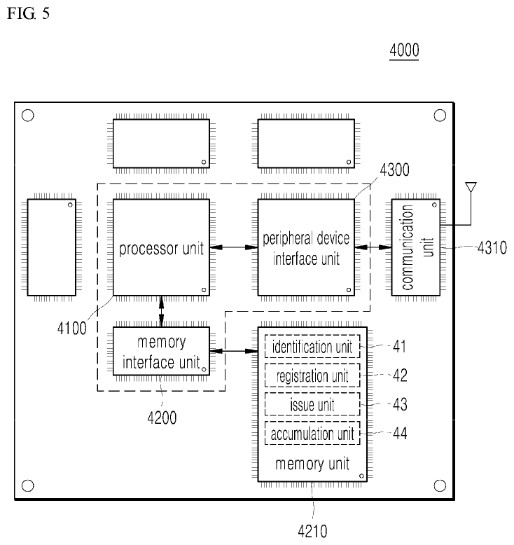

For reference, since the configuration of the communication unit 26 is the configuration corresponding to a communication unit 4310 to be described with reference to FIG. 5, a detailed description thereof will be made below.

As a result, the payment service device 40 according to an embodiment of the present disclosure may automatically process the issue of electronic receipts and the accumulation of points through the above-described configuration when the purchaser performs payment using the payment card and, hereinafter, each element within the payment service device 40 for implementing it will be described in more detail.

The identification unit 41 performs a function of identifying a payment card which the purchaser has registered.

Specifically, the identification unit 41 identifies card information of the payment card which the purchaser configures as a target to issue electronic receipts and accumulate points and the card company device 30 for processing approval of payment by the corresponding payment card based on purchaser configuration information configured by the purchaser.

The purchaser configuration information may be managed for each purchaser in the form of a matching table including card information of the payment card which the purchaser configures as the target to issue electronic receipts and accumulate points, point card information that matches thereto, and identification information (phone number) of the purchaser terminal 10.

The registration unit 42 performs a function of registering the target to issue electronic receipts and accumulate points.

Specifically, when the card information of the payment card which is configured as the target to issue electronic receipts and accumulate points and the card company device 30 for processing the approval of payment by the corresponding payment card are identified based on the purchaser configuration information, the registration unit 42 may transfer the identified card information of the payment card to the card company device 30 and allow the card company device 30 to register and manage the card information of the corresponding payment card as the target to issue electronic receipts and accumulate points.

In connection with this, the card company device 30 registers the card information of the payment card received from the payment service device 40 as the target to issue electronic receipts and accumulate points and then, when the approval of payment by the corresponding payment card is processed according to a request from the affiliated store terminal 20, transmits a payment approval response including service target identification information (flag) indicating the target to issue electronic receipts and accumulate points to the affiliated store terminal 20.

The issue unit 43 performs a function of issuing electronic receipts.

Specifically, when receiving a request for issuing electronic receipts and accumulating points from the affiliated store terminal 20, the issue unit 43 issues electronic receipts for payment details approved by the card company device 30.

At this time, the issue 43 receives a request message including affiliated store information, card information of the payment card, and payment details from the affiliated store terminal 20, issues electronic receipts for the payment details to the purchaser who matches the corresponding card information, and transmits the issued electronic receipts to the purchaser terminal 10, so that the purchaser may identify the electronic receipts.

Meanwhile, before issuing the electronic receipts the issue unit 43 may first determine whether the electronic receipts can be issued and issue the electronic receipts to the purchaser only when it is determined that the electronic receipts can be issued.

At this time, whether the electronic receipts can be issued may be determined based on location information of the purchaser terminal 10.

That is, the issue unit 43 may identify a location of the corresponding purchaser terminal 10 at a time point at which the request message is received from the affiliated store terminal 20 based on location information of the purchaser terminal 10 and, when a difference between the identified location of the purchaser terminal 10 and the location of the affiliated store terminal 20 is shorter than a threshold distance, determine that the electronic receipts can be issued.

As described above, determining that the electronic receipts can be issued when the difference between the location of the purchaser terminal 10 and the location of the affiliated store terminal 20 is shorter than the threshold distance may be understood as a series of security policies to issue electronic receipts to the purchaser only when it is identified the purchaser is actually located in the affiliated store based on the location of the purchaser terminal 10.

For reference, the location of the affiliated store terminal 20 may be registered and managed while matching affiliated store information received from the affiliated store terminal 20.

The accumulation unit 44 performs a function of accumulating points.

Specifically, when the issue of electronic receipts to the purchaser is completed, the accumulation unit 44 may accumulate points corresponding to payment details of the point card information of the purchaser who matches the card information and transmit a result of the corresponding point accumulation to the purchaser terminal 10, so that the purchaser may identify the accumulated points.

Meanwhile, before accumulating points to the purchaser, the accumulation unit 44 may verify validity of a request for accumulating points and accumulate points to the purchaser only when the validity is verified.

At this time, the validity of the request for accumulating points may be verified according to a result of comparison between payment details received from the affiliated store terminal 20 and payment details identified from a predefined affiliated store terminal group.

That is, the accumulation unit 44 may compare the payment details received from the affiliated store terminal 20 and the payment details identified from the predefined affiliated store terminal group and, when the payment details match each other based on the comparison result, verify that the request for accumulating points is valid.

The affiliated store terminal group is a group of affiliated store terminals which have accumulated points a predetermined number of times or more (for example, three times) to the purchaser during a predetermined period (for example, recent three months) and may be understood as a group of which validity for the request for accumulating points has been already verified.

Of course, conditions for generating the affiliated store terminal group is not limited to histories of point accumulation, but may include a payment amount-based condition under which payment amount included in the payment details exceeds than set amount or payment amount exceeds average payment amount by the set amount.

Information on the affiliated store terminal group may be shared with the card company device 30 during a process of registering card information, which is the target to issue electronic receipts and accumulate points in the card company device 30.

When approving the request for payment from the affiliated store terminal 20, the card company device 30 may transmit the approved payment details not only to the affiliated store terminal 20 but also each terminal included in the affiliated store terminal group and thus the affiliated store terminal group may share the approved payment details.

Meanwhile, the verification of validity of the request for accumulating points may be restrictively performed only in a specific situation as a series of security policies for preventing illegal point accumulation.

The specific situation may be understood as a situation in which the affiliated store terminal 20 making a request for accumulating points has no point accumulation history of the purchaser during a predetermined period (for example, recent three months) or the number of times by which points are accumulated for the purchaser is smaller than a predetermined number of times (for example, three times).

This may be understood that a separate validity verification is not performed if the affiliated store terminal 20 making a request for accumulating points belongs to the affiliated store terminal group of which validity has been already verified.

Meanwhile, each element within the payment service device 40 may be implemented in the form of a software module or a hardware module executed by the processor or in the form of a combination of a software module and a hardware module.

As described above, the software module and the hardware module executed by the processor, and the combination of the software module and the hardware module may be implemented by a hardware system (for example, a computer system).

Accordingly, hereinafter, a hardware system 4000 in which the payment service device 40 according to an embodiment of the present disclosure is implemented in the hardware form will be described with reference to FIG. 5.

For reference, the following description is an example of a hardware system 4000 in which each element within the payment service device 40 is implemented, but it should be noted that each element and the operation thereof are different from those of the actual system.

As illustrated in FIG. 5, the hardware system 4000 according to an embodiment of the present disclosure may include a processor unit 4100, a memory interface unit 4200, and a peripheral device interface unit 4300.

The respective elements within the hardware system 4000 may be individual elements, or may be integrated into one or more integrated circuits, and may be combined by a bus system (not shown).

The bus system is an abstraction indicating one or more individual physical buses, communication lines/interfaces, multi-drop, and/or point-to-point connections connected by bridges, adaptors, and/or controllers as appropriate.

The processor unit 4100 may serve to execute various software modules stored in the memory unit 4210 by communicating with the memory unit 4210 through the memory interface unit 4200 in order to perform various functions in the hardware system.

The memory unit 4210 may store an identification unit 41, a registration unit 42, an issue unit 43, and an accumulation unit 44, which are elements within the payment service device 40 described with reference to FIG. 4, in the form of a software module and further include an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 4210 includes a cache, a main memory, and a secondary memory, but is not limited thereto, and may include a memory layer structure. The memory layer structure may be implemented through a predetermined combination of, for example, RAM (for example, SRAM, DRAM, or DDRAM), ROM, FLASH, a magnetic and/or optical storage device (for example, a disk drive, a magnetic tape, a Compact Disk (CD), and a Digital Video Disc (DVD)).

The peripheral interface unit 4300 serves to enable communication between the processor unit 4100 and peripheral devices.

The peripheral device may provide different functions to the hardware system 4000, and may include, for example, a communication unit 4310 according to an embodiment of the present disclosure.

The communication unit 4310 serves to provide a function of communication with another device. To this end, the communication unit 1310 may include, for example, an antenna system, an RF transceiver, one or more amplifiers, a tuner, one or more oscillators, a digital signal processor, a CODEC chipset, and a memory, but is not limited thereto, and may include a known circuit for performing the function.

Communication protocols supported by the communication unit 4310 may include, for example, Wireless LAN (WLAN), Digital Living Network Alliance (DLNA), Wireless broadband (Wibro), World interoperability for microwave access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, and Wi-Fi Direct. Wired communication networks may include wired Local Area Network (LAN), wired Wide Area Network (WAN), Power Line Communication (PLC), USB communication, Ethernet, serial communication, and optical fiber/coaxial cable, but are not limited thereto and may include any protocol that can provide a communication environment with another device.

As a result, each element within the affiliated store terminal 20 stored in the memory unit 4210 of the hardware system 4000 according to an embodiment of the present disclosure in the form of a software module may execute an interface with the communication unit 4310 via the memory interface unit 4200 and the peripheral device interface unit 4300 in the form of instructions executed by the processor unit 4100, thereby automatically issuing electronic receipts and accumulating points for payment details approved by the card company device 30 without a separate intervention of the purchaser.

As described above, according to the payment service system and each element within the system according to an embodiment of the present disclosure, it is possible to significantly improve convenience of the purchaser by pre-registering a payment card (for example, a credit card) for the issue of electronic receipts and the accumulation of points and automatically processing the issue of electronic receipts and the accumulation of points when the purchaser performs payment using the registered payment card.

Hereinafter, the operation flow in the payment service system according to an embodiment of the present disclosure will be subsequently described.

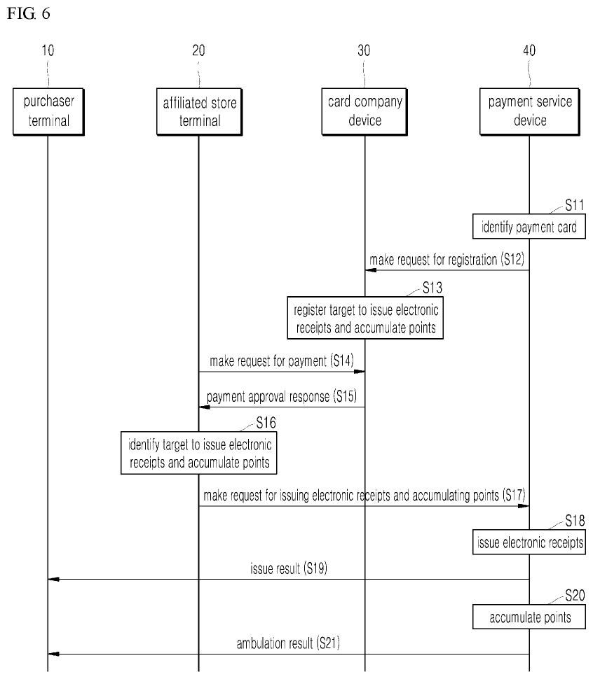

In connection with this, FIG. 6 illustrates the operation flow in the payment service system according to an embodiment of the present disclosure.

First, the payment service device 40 identifies card information of the payment card which the purchaser configures as the target to issue electronic receipts and accumulate points and the card company device 30 for processing approval of payment by the corresponding payment card based on purchaser configuration information configured by the purchaser in S11.

The purchaser configuration information may be managed for each purchaser in the form of a matching table including card information of the payment card which the purchaser configures as the target to issue electronic receipts and accumulate points, point card information that matches thereto, and identification information (phone number) of the purchaser terminal 10.

Then, when the card information of the payment card which the purchaser configures as the target to issue electronic receipts and accumulate points and the card company device 30 for processing the approval of payment by the corresponding payment card are identified based on purchaser configuration information, the payment service device 40 may transfer the identified card information of the payment card and thus allow the card company device 30 to register and mange the card information of the corresponding payment card as the target to issue electronic receipts and accumulate points in S12.

The card company device 30 registers the card information of the payment card received from the payment service device 40 as the target to issue electronic receipts and accumulate points and then, when the approval of payment by the corresponding payment card is processed according to a request from the affiliated store terminal 20, transmits a payment approval response including service target identification information (flag) indicating the target to issue electronic receipts and accumulate points to the affiliated store terminal 20 in S13.

The affiliated store terminal 20 makes a request for approving payment by the payment card to the card company device 30 by transferring a payment approval request to the card company device 30 according to a request for payment using the payment card of the purchaser in S14.

At this time, the affiliated store terminal 20 may make a request for approving payment by the payment card by acquiring card information of the payment card and transferring a payment approval request including the acquired card information to the card company device 30.

Then, when the request for payment by the payment card is approved by the card company device 30 and thus a payment approval response thereto is received from the card company device 30, the affiliated store terminal 20 identifies that the payment card by which the request for payment is made is the target to issue electronic receipts and accumulate points based on the received payment approval response in S15 and S16.

At this time, the payment approval response received from the card company device 30 may include card information of the approved payment, that is, service target identification information (flag) indicating the target to issue electronic receipts and accumulate points, and the identification unit 22 may identify that the payment card by which the request for payment is made is the target to issue electronic receipts and accumulate points based on the service target identification information.

To this end, the card company device 30 may receive card information of the payment card configured as the target to issue electronic receipts and accumulate points by the purchaser from the payment service device 40 and register and manage the card information, and thus may transmit the payment approval response including the service target identification information (flag) indicating the target to issue electronic receipts and accumulate points to the affiliated store terminal 20 when the payment by the corresponding payment card is approved.

Then, when it is identified that the payment card by which the request for payment is made is the target to issue electronic receipts and accumulate points based on the payment approval response received from the card company device 30, the affiliated store terminal 20 makes a request for issuing electronic receipts and accumulating points for payment details approved by the card company device 30 to the payment service device 40 in S17.

At this time, the request unit 23 makes a request for issuing electronic receipts and accumulating points for payment details approved by the card company device 30 by transferring an issuing and accumulating request message including affiliated store information, card information of the payment card, and payment details to the payment service device 40.

When the issuing and accumulating request message is received from the affiliated store terminal 20, the payment service device 40 may issue electronic receipts for payment details to the purchaser who matches card information and transmit the issued electronic receipts to the purchaser terminal 10, so that the purchaser may identify the electronic receipts in S18 and S19.

Thereafter, after issuing the electronic receipts, the payment service device 40 may accumulate points corresponding to payment details for point card information of the purchaser who matches card information and transmit the result of the corresponding point accumulation to the purchaser terminal 10, so that the purchaser may identify the accumulated points in S20 and S21.

To this end, before issuing electronic receipts and accumulating points to the purchaser, the payment service device 40 may register and manage purchaser configuration information including card information of the payment card which the purchaser configures as the target to issue electronic receipts and accumulate points, point card information that matches thereto, and identification information (phone number) of the purchaser terminal 10 in the form of a matching table.

The description for the operation flow in the payment service system according to an embodiment of the present disclosure has been completed and the operation flow in the affiliated store terminal 20 will be subsequently described.

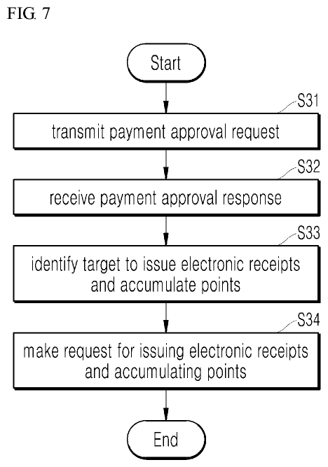

In connection with this, FIG. 7 illustrates the operation flow in the affiliated store terminal 20 according to an embodiment of the present disclosure.

First, the payment unit 21 makes a request for approving payment by the payment card to the card company device 30 by transferring a payment approval request to the card company device 30 according to a request for payment using the payment card of the purchaser in S31.

At this time, the payment unit 21 may make a request for approving payment by the payment card by acquiring card information of the payment card and transferring a payment approval request including the acquired card information to the card company device 30.

Then, when the request for payment by the payment card is approved by the card company device 30 and thus a payment approval response thereto is received from the card company device 30, the identification unit 22 identifies that the payment card by which the request for payment is made the target to issue electronic receipts and accumulate points based on the received payment approval response in S32 and S33.

At this time, the payment approval response received from the card company device 30 may include card information of the approved payment, that is, service target identification information (flag) indicating the target to issue electronic receipts and accumulate points, and the identification unit 22 may identify that the payment card by which the request for payment is made is the target to issue electronic receipts and accumulate points based on the service target identification information.

To this end, the card company device 30 may receive card information of the payment card configured as the target to issue electronic receipts and accumulate points by the purchaser from the payment service device 40 and register and manage the card information, and thus may transmit the payment approval response including the service target identification information (flag) indicating the target to issue electronic receipts and accumulate points to the affiliated store terminal 20 when the payment by the corresponding payment card is approved.

Thereafter, when it is identified that the payment card by which the request for payment approval is made is the target to issue electronic receipts and accumulate points based on the payment approval response received from the card company device 30, the request unit 23 makes a request for issuing electronic receipts and accumulating points for payment details approved by the card company device 30 to the payment service device 40 in S34.

At this time, the request unit 23 makes a request for issuing electronic receipts and accumulating points for payment details approved by the card company device 30 by transferring an issuing and accumulating request message including affiliated store information, card information of the payment card, and payment details to the payment service device 40.

In connection with this, when the issuing and accumulating request message is received from the affiliated store terminal 20, the payment service device 40 may issue electronic receipts for payment details to the purchaser who matches the card information and transmit the issued electronic receipts to the purchaser terminal 10, so that the purchaser may identify the issued electronic receipts.

Further, after the electronic receipts are issued, the payment service device 40 may accumulate points corresponding to the payment details of point card information of the purchaser who matches the card information and transmit a result of the corresponding point accumulation to the purchaser terminal 10, so that the purchaser may identify the accumulated points.

To this end, before issuing electronic receipts and accumulating points to the purchaser, the payment service device 40 may register and manage purchaser configuration information including card information of the payment card which the purchaser configures as the target to issue electronic receipts and accumulate points, point card information that matches thereto, and identification information (phone number) of the purchaser terminal 10 in the form of a matching table.

The description for the operation flow in the affiliated store terminal 20 according to an embodiment of the present disclosure has been completed and the operation flow in the payment service device 40 will be subsequently described.

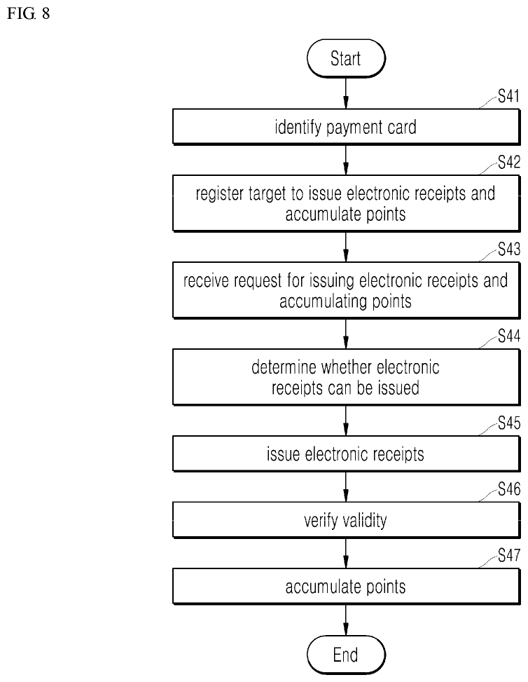

In connection with this, FIG. 8 illustrates the operation flow in the payment service device 40 according to an embodiment of the present disclosure.

First, the identification unit 41 identifies card information of the payment card which the purchaser configures as the target to issue electronic receipts and accumulate points based on purchaser configuration information configured by the purchaser and the card company device 30 for processing approval of payment by the corresponding payment card in S41.

The purchaser configuration information may be managed for each purchaser in the form of a matching table including card information of the payment card which the purchaser configures as the target to issue electronic receipts and accumulate points, point card information that matches thereto, and identification information (phone number) of the purchaser terminal 10.

Then, when the card information of the payment card which the purchaser configures as the target to issue electronic receipts and accumulate points and the card company device 30 for processing the approval of payment by the corresponding payment card are identified based on purchaser configuration information, the registration unit 42 may transfer the identified card information of the payment card and thus allow the card company device 30 to register and mange the card information of the corresponding payment card as the target to issue electronic receipts and accumulate points in S42.

In connection with this, the card company device 30 registers the card information of the payment card received from the payment service device 40 as the target to issue electronic receipts and accumulate points and then, when the approval of payment by the corresponding payment card is processed according to a request from the affiliated store terminal 20, transmits a payment approval response including service target identification information (flat) indicating the target to issue electronic receipts and accumulate points to the affiliated store terminal 20.

When a request message including affiliated store information, card information of the payment card, and payment details is received from the affiliated store terminal 20 and a request for issuing electronic receipts and accumulating points is made, the issue unit 43 first determines whether the electronic receipts can be issued in S43 and S44.

At this time, whether the electronic receipts can be issued may be determined based on location information of the purchaser terminal 10.

That is, the issue unit 43 may identify a location of the corresponding purchaser terminal 10 at a time point at which the request message is received from the affiliated store terminal 20 based on location information of the purchaser terminal 10 and, when a difference between the identified location of the purchaser terminal 10 and the location of the affiliated store terminal 20 is shorter than a threshold distance, determine that the electronic receipts can be issued.

As described above, determining that the electronic receipts can be issued when the difference between the location of the purchaser terminal 10 and the location of the affiliated store terminal 20 is shorter than the threshold distance may be understood as a series of security policies to issue electronic receipts to the purchaser only when it is identified the purchaser is actually located in the affiliated store based on the location of the purchaser terminal 10.

For reference, the location of the affiliated store terminal 20 may be registered and managed while matching affiliated store information received from the affiliated store terminal 20.

Then, when it is determined that the electronic receipts can be issued, the issue unit 43 may issue the electronic receipts for payment details to the purchaser who matches card information and transmit the issued electronic receipts to the purchaser terminal 10, so that that the purchaser may identify the electronic receipts in S45.

Next, when the issue of the electronic receipts to the purchaser is completed, the issue unit 44 verifies validity of the request for point accumulation prior to the point accumulation for the purchaser in S46.

At this time, the validity of the request for accumulating points may be verified according to a result of comparison between payment details received from the affiliated store terminal 20 and payment details identified from a predefined affiliated store terminal group.

That is, the accumulation unit 44 may compare the payment details received from the affiliated store terminal 20 and the payment details identified from the predefined affiliated store terminal group and, when the payment details match each other based on the comparison result, verify that the request for accumulating points is valid.

The affiliated store terminal group is a group of affiliated store terminals which have accumulated points a predetermined number of times or more (for example, three times) to the purchaser during a predetermined period (for example, recent three months) and may be understood as a group of which validity for the request for accumulating points has been already verified.

Of course, conditions for generating the affiliated store terminal group is not limited to histories of point accumulation, but may include a payment amount-based condition under which payment amount included in the payment details exceeds than set amount or payment amount exceeds average payment amount by the set amount.

Information on the affiliated store terminal group may be shared with the card company device 30 during a process of registering card information, which is the target to issue electronic receipts and accumulate points in the card company device 30.

When approving the request for payment from the affiliated store terminal 20, the card company device 30 may transmit the approved payment details not only to the affiliated store terminal 20 but also each terminal included in the affiliated store terminal group and thus the affiliated store terminal group may share the approved payment details.

Meanwhile, the verification of validity of the request for accumulating points may be restrictively performed only in a specific situation as a series of security policies for preventing illegal point accumulation.

The specific situation may be understood as a situation in which the affiliated store terminal 20 making a request for accumulating points has no point accumulation history of the purchaser during a predetermined period (for example, recent three months) or the number of times by which points are accumulated for the purchaser is smaller than a predetermined number of times (for example, three times).

This may be understood that a separate validity verification is not performed if the affiliated store terminal 20 making a request for accumulating points belongs to the affiliated store terminal group of which validity has been already verified.

Thereafter, when it is verified that the request for accumulating points is valid based on the verification result, the accumulation unit 44 may accumulate points corresponding to payment details for point card information of the purchaser who matches card information and transmit the result of the corresponding point accumulation to the purchaser terminal 10, so that the purchaser may identify the accumulated points in S47.

As described above, according to the payment service system and the operation flow in each element within the system according to an embodiment of the present disclosure, it is possible to significantly improve convenience of the purchaser by pre-registering a payment card (for example, a credit card) for the issue of electronic receipts and the accumulation of points and automatically processing the issue of electronic receipts and the accumulation of points when the purchaser performs payment using the registered payment card.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

### INDUSTRIAL APPLICABILITY

The present disclosure, pertaining to the payment service device and the method of operating the same, has industrial applicability since the technology is relevant and useful in that the present disclosure overcomes the limit of the prior art, the applied device is sufficient to be brought to market and sold, and it is obvious that the applied device is practicably realized in that a payment card (for example, a credit card) can be pre-registered to issue electronic receipts and accumulate points and the issue of electronic receipts and the accumulation of points can be automatically processed when the purchaser performs payment using the registered payment card.

What is claimed is:

1. A payment service device comprising:
a processor configured to process calculations related to issue of electronic receipts and accumulation of points; and
a memory configured to store at least one command executed through the processor,
wherein the at least one command comprises:
an identification command for causing the processor to identify a payment card which a purchaser registers to issue electronic receipts and accumulate points; and
a registration command for causing the processor to register the payment card in a card company device for issuing electronic receipts and accumulating points, so that the card company device receiving a payment approval request for the payment card from an affiliated store terminal can instruct the affiliated store terminal to issue electronic receipts and accumulate points.

2. The payment service device of claim 1, wherein the at least one command further comprises:
an issue command for causing the processor to issue electronic receipts for payment details approved by the card company device when it is determined that electronic receipts can be issued based on location information of a purchaser terminal.

3. The payment service device of claim 2, wherein the issue command causes the processor to determine that the electronic receipts can be issued when a difference between a location of the purchaser terminal identified based on the location information and a location of the affiliated store terminal is shorter than a threshold distance.

4. The payment service device of claim 1, wherein the at least one command further comprises:
an accumulation command for causing the processor to accumulate points for payment details approved by the card company device according to the issue of electronic receipts.

5. The payment service device of claim 4, wherein the accumulation of points is performed according to payment details received from the affiliated store terminal when payment details received from the affiliated store terminal are equal to payment details identified from a predefined affiliated store terminal group.

6. The payment service device of claim 5, wherein, when payment according to the payment approval request is approved, the card company device is configured to share approved payment details with each terminal belonging to the affiliated store terminal group.

7. A method of operating a payment service device, the method comprising:
identifying a payment card which a purchaser registers to issue electronic receipts and accumulate points; and
registering the payment card in a card company device for issuing electronic receipts and accumulating points so that the card company device receiving a payment approval request for the payment card from an affiliated store terminal can instruct the affiliated store terminal to issue electronic receipts and accumulate points.

8. The method of claim 7, wherein the method further comprises:
when it is determined that electronic receipts can be issued based on location information of a purchaser terminal, issuing electronic receipts for payment details approved by the card company device.

9. The method of claim 8, wherein issuing the electronic receipts comprises:
when a difference between a location of the purchaser terminal identified based on the location information and a location of the affiliated store terminal is shorter than a threshold distance, determining that the electronic receipts can be issued.

10. The method of claim 7, wherein the method further comprises:
accumulating points for payment details approved by the card company device according to the issue of electronic receipts.

11. The method of claim 10, wherein accumulating the points is performed according to payment details received from the affiliated store terminal when payment details received from the affiliated store terminal are equal to payment details identified from a predefined affiliated store terminal group.

12. The method of claim 5, wherein the method comprises:
when payment according to the payment approval request is approved, sharing, by the card company device, approved payment details with each terminal belonging to the affiliated store terminal group.
